(19) United States
(12) Patent Application Publication
(10) Pub. No.: US 2010/0057944 A1
(43) Pub. Date: Mar. 4, 2010

(54) Plug connector module

(75) Inventor: Holger Eberhard, Backnang (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft fur Mess - und Regeltechnik mbH + Co. KG, Gerlingen (DE)

(21) Appl. No.: 12/458,613

(22) Filed: Jul. 17, 2009

(30) Foreign Application Priority Data
Jul. 12, 2008 (DE) 10 2008 034078.2

(51) Int. Cl. G06F 3/00; H01R 13/66; H01R 13/62

(52) U.S. Cl. 710/10; 439/620.01; 439/304

(57) ABSTRACT

A plug connector module having at least one plug connector for electromechanical connection with a field device, especially a device for measured data capture in process technology. The plug connector module includes a memory unit for storing data and a communication interface, which enables a data connection with the field device.

### TECHNICAL FIELD

The invention relates to a plug connector module having at least one plug connector for electromechanical connection with a field device, especially a device for measured data capture in process technology.

### BACKGROUND DISCUSSION

Conventional plug connectors and plug connector modules serve solely for electromechanical contacting of devices, such as e.g. devices for measured data capture in process technology, for example, for establishing a data connection with a data bus such as e.g. a fieldbus. Moreover, plug connectors are known, which offer an integrated test functionality, in order to test a data connection implemented by means of a plug connector. In this way, e.g. wrong wiring of data lines and lacking, or defective, bus termination can be detected. Corresponding status reports are signaled, for example, optically by light-emitting diodes arranged in the plug connectors.

### SUMMARY OF THE INVENTION

It is an object of the present invention to improve a plug connector module of the initially described type toward the goal of providing an increased utility.

This object is achieved in the case of the plug connector module of the initially described type, according to the invention, by the features that: the plug connector module includes a memory unit for storing data; and a communication interface is provided, which enables a data connection with a field device. Via the communication interface of the invention, advantageously, data from a field device connected with the plug connector module can be transferred into the plug connector module, to then be stored in the memory unit of the invention for later application.

In this way, advantageously, the opportunity is given for exchanging data between different field devices in especially simple manner. Especially, the plug connector module of the invention can be used for transmission of configuration data from a first field device to a second field device.

In the case of an especially preferred form of embodiment of the present invention, the plug connector module is embodied in such a manner that it can read out the configuration data of a connected field device automatically via the communication interface and store such in the memory unit, so that advantageously no special technical knowledge concerning the servicing of the field device is required, in order to transfer its configuration data to the plug connector module of the invention.

In the case of an additional, especially preferred form of embodiment of the present invention, the plug connector module is embodied in such a manner that configuration data stored in the memory unit can be transferred automatically via the communication interface to a connected field device, so that also the configuration of a new device is implementable without special technical knowledge solely by application of an earlier stored configuration of an existing field device.

The above described automatic read-out and transferring, respectively, is preferably controlled by a suitable communication protocol, which is implemented both in the plug connector module of the invention as well as also in the corresponding field device. The automatic read-out and transferring, respectively, can, for example, always take place, once the plug connector module of the invention has been connected via one of its plug connectors with a field device of concern. The process flow control of the plug connector module of the invention can occur in manner known per se, e.g. via an integrated microcontroller, which both controls the communication interface as well as also being able to access the memory unit.

Especially beneficially, using the plug connector module of the invention, especially also in the case of a data bus system, addresses of participating field devices can be stored and/or transferred between different field devices. For example, in the case of Profibus compatible field devices, in this way, a Profibus address of a field device can almost automatically be transferred between different field devices, whereby, advantageously, an especially frequent source of malfunction in the case of a device replacement is prevented.

A service person, for the transferring of the Profibus address and other configuration data of an old field device to a new field device, need only connect the plug connector module of the invention with the old, already configured, field device, in order to store its data automatically locally in the plug connector module of the invention. Then, the service person connects the plug connector module of the invention with the new, not already configured, field device, in order to retrieve the configuration data stored locally in the plug connector module of the invention and to transfer such to the new field device. A manual configuration of the new field device, with the sources of error associated therewith, becomes unnecessary through the use of the invention.

An especially reliable storing of data in the plug connector module of the invention is provided in an additional form of embodiment, when the memory unit includes a non-volatile memory, especially an EEPROM (electrically erasable, programmable ROM), and/or a flash EEPROM, and/or MRAM (magnetoresistive RAM)-memory.

An especially easy expandability of the plug connector module of the invention as regards local data storage is provided in an additional variant of the invention, according to which the memory unit includes a memory interface for connection with an external memory module, especially a USB (Universal Serial Bus) memory module or an SD memory card (Secure Digital memory card).

In order to prevent an unauthorized removal of the external memory module, or a separation of the external memory module from the plug connector module, according to the invention, additionally, means for locking the external memory module can be provided, which, for example, are mechanically embodied.

In general, it is also an option to construct the plug connector module of the invention in such a manner, that it logs all events (connecting with, or removal of, a field device, etc.) and stores such locally in one or more log files, in order to enable subsequent evaluation.

Especially advantageously in the case of an additional variant of the invention, it is provided, that the communication interface is formed by electromechanical connection implemented via the at least one plug connector, wherein, especially, a data line of the connection implemented via the at least one plug connector is used for forming a 1-wire interface. In this way, resources present, in any event, on the field device, or in a corresponding plug connector, are optimally utilized.

Instead of a 1-wire interface, also other data connections can be established, whose configuration is limited solely by the number, or wiring, of data lines in a corresponding plug connector or field device. In the case of a plug connector with sufficiently many data lines, e.g. also the forming a parallel interface is an option for enabling data exchange between the field device and the plug connector module.

In the case of an additional advantageous variant of the invention, the communication interface is formed by a wireless and/or optical data connection, and the plug connector module includes means for establishing a wireless and/or optical data connection with the field device, for example, a ZigBee- or Bluetooth-compatible transceiver and/or an optical transceiver.

Especially in the case of the wireless data connection, it is no longer necessarily required, to plug the plug connector module of the invention with a plug connector into the pertinent field device. However, the added establishing of the electromechanical connection by the plug connector can be used advantageously, for example, to start the automatic data exchange e.g. via the wireless data connection.

Preferably, the plug connector module of the invention includes an integrated energy source for electrical energy supply, in the case of which it can be, preferably, a long-lived battery or also a high capacitance capacitor, especially a so-called double layer capacitor.

Alternatively or supplementally, also an integrated energy supply unit for electrical energy supply can be provided, which is embodied to store and/or to transform electrical energy received via a plug connector of the field device or via a data bus. For this, the integrated energy supply unit can utilize suitable (dc-)voltage converters, etc.

Preferably, the plug connector module of the invention also includes integrated means for interference suppression, which can be formed, especially, by at least one interference suppression resistor, which is connected, especially serially, with a data line of the at least one plug connector. More complex filter networks, bandpass filters, components for deflection of overvoltages, etc. can likewise be integrated in the plug connector module of the invention.

The plug connector module of the invention can, advantageously, also include a number of different plug connectors, so that it can be used with different field devices, or systems. The different plug connectors can in such case differ both as regards their mechanical shape as well as also the electrical parameters or a combination thereof.

The plug connector module of the invention can, in the case of a sufficiently large memory capacity, advantageously also be used as a data logger for recording the measured values or other operational variables of a field device connected with it. For example, the plug connector module of the invention can be fixedly associated with a certain measuring point and, in the case of a device replacement, can be transferred from the old field device to the new field device, so that a continued data recording of relevant parameters of the measuring point is provided also during the device replacement and beyond. In this way, as it were, a measuring point referenced “log book” is implementable over a number of installed device generations and beyond.

Information for identity, or compatibility, testing of field devices to be connected is likewise storable in the plug connector module of the invention. In this way, data sets to be stored can be especially safely associated with a certain field device.

Other features, opportunities for application and advantages of the invention will become evident from the following description of examples of embodiments of the invention presented in the figures of the drawing. In such case, all described or illustrated features alone or in any combination form the subject matter of the invention, independently of their summarizing in the patent claims or their dependence, as well as independently of their formulation, or presentation in the description or in the drawing.

### BRIEF DESCRIPTION OF THE DRAWINGS

The figures of the drawing show as follows:

FIG. 1 a schematic block diagram of a first form of embodiment of the plug connector module of the invention;

FIG. 2a a schematic block diagram of a second form of embodiment of the plug connector module of the invention; and

FIG. 2b a schematic block diagram of an additional form of embodiment of the plug connector module of the invention.

### DETAILED DISCUSSION IN CONJUNCTION WITH THE DRAWINGS

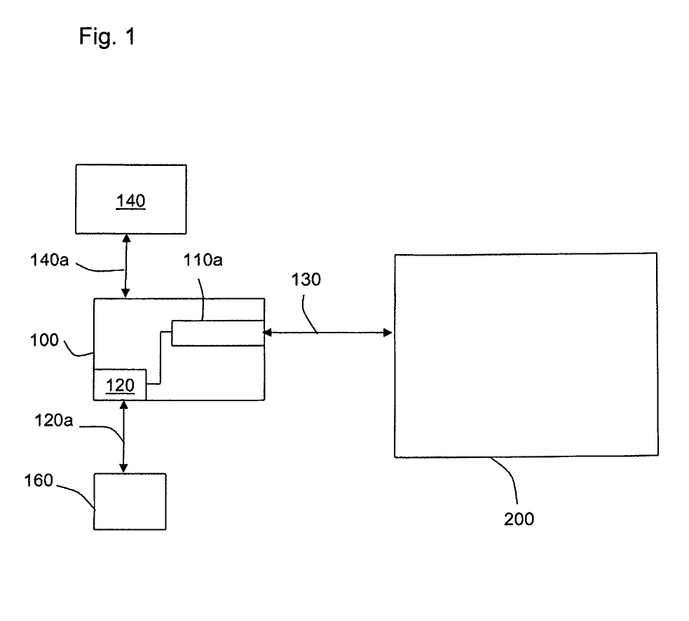

FIG. 1 shows a schematic block diagram of a first form of embodiment of a plug connector module 100 of the invention. The plug connector module 100 includes a plug connector 110a for electromechanical connection with a field device 200, which can be, especially, a device for measured data capture in process technology.

According to the invention, the plug connector module 100 includes a communication interface 130, so that data exchange is possible with the field device 200 via the communication interface 130. For local data storage, the plug connector module 100 of the invention includes a memory unit 120, which preferably is integrated in the plug connector module 100. An especially secure and reliable data storage is provided, when the memory unit 120 includes a non-volatile memory, especially an EEPROM and/or flash EEPROM and/or MRAM memory, which assures data retention, especially also in the absence of a permanent electrical energy supply.

Via the communication interface 130 of the invention, advantageously, data of the field device 200 connected with the plug connector module 100 can be transferred into the plug connector module 100, to then be stored in the memory unit 120 of the invention for later application.

In this way, advantageously, the opportunity is provided for exchanging, in especially simple manner, data between different field devices 200. Especially, the plug connector module 100 of the invention can be used for transmission of configuration data from a first field device 200 to a second field device (not shown), for example, in the case of a device replacement or the introduction of a new, yet to be configured device.

In the case of an especially preferred form of embodiment of the present invention, the plug connector module 100 is embodied to read out the configuration data of the connected field device 200 automatically via the communication interface 130 and to store such in the memory unit 120, so that, advantageously, no special technical knowledge concerning the servicing of the field device 200 is required, in order to transfer its configuration data to the plug connector module of the invention. The simple establishing of the plugged connection between the plug connector module 100 and the field device 200 is sufficient, in order to start the data exchange of the invention.

In the case of an additional, especially preferred form of embodiment of the present invention, the plug connector module 100 is embodied to transfer configuration data stored in the memory unit 120 automatically via the communication interface 130 to a connected field device 200, so that also the configuration of a new device is implementable without special technical knowledge solely using an earlier stored configuration of an existing field device 200.

The above described automatic read-out and transferring, respectively, is preferably controlled through a suitable communication protocol, which is implemented both in the plug connector module 100 of the invention as well as also in the corresponding field device 200. The automatic read-out and transferring, respectively, can, for example, always take place, once the plug connector module 100 of the invention has been connected via one of its plug connectors 110a with a field device 200 of concern.

The process flow control of the plug connector module 100 of the invention can occur in manner known per se, e.g. using an integrated microcontroller (not shown), which both controls the communication interface 130 as well as also being able to access the memory unit 120.

An especially easy expandability of the plug connector module 100 of the invention as regards local data storage is provided in an additional variant of the invention, in which the memory unit 120 has a memory interface 120a for connection with an external memory module 160, especially a USB (Universal Serial Bus) memory module or an SD memory card (Secure Digital memory card).

The plug connector module 100 of the invention can, in the case of a sufficiently large memory capacity, advantageously also be used as a data logger for recording measured values or other operational variables of the field device 200 connected with it. For example, the plug connector module 100 of the invention can be fixedly associated with a certain measuring point, e.g. a measuring point for registering a pH value in a process chain, and can be transferred, in the case of a device replacement, from the old field device 200 to the new field device, so that a continued data recording of relevant parameters of the pH measuring point is provided also during the device replacement and beyond. In this way, as it were, a measuring point referenced “log book” is implementable over a number of installed device generations and beyond.

Information for identity, or compatibility, testing of field devices 200 to be connected is likewise storable in the plug connector module 100 of the invention. In this way, data sets to be stored can, especially, be safely and reliably associated with a certain field device 200.

In order to prevent unauthorized removal of the external memory module 160, according to the invention, additionally, means (not shown) for locking the external memory module 160 can be provided, wherein the means are, for example, mechanically embodied.

In general it is also an option to construct the plug connector module 100 of the invention in such a manner that it logs all events (connecting with, or removal of, the field device 200, etc.) and stores such locally in one or more log files, in order to enable subsequent evaluation.

Especially advantageously in the case of an additional variant of the invention, it is provided, that the communication interface 130 is formed by the electromechanical connection implemented via the at least one plug connector 110a, wherein especially a data line (not shown) of the connection implemented via the at least one plug connector 110a is used for forming a 1-wire interface. In this way, resources present, in any event, on the field device 200, or in a corresponding plug connector 110a, are optimally utilized.

Instead of a 1-wire interface, also other data connections can be established, whose configuration is limited solely by the number, or wiring, of data lines in a corresponding plug connector 110a, or field device 200. In the case of a plug connector with sufficiently many data lines, e.g. also the forming of a parallel interface is an option, in order to enable the data exchange between the field device and the plug connector module.

When the field device 200 involves, for example, a Profibus compatible system, then the plug connectors 110a of the plug connector module 100 of the invention can advantageously likewise be designed to be Profibus compatible, and the communication interface 130 is defined by the Profibus standard.

Alternatively or supplementally, according to the invention, also individual or a number of data lines of the Profibus compatible, plugged connection 110a can be used for implementing another kind of data connection, or other protocol; compare the above described, 1-wire interface.

Via a system interface 140a, e.g. a Profibus interface, a 4-20 mA transmitter, a current loop, or the like, the plug connector module 100 is connected with a superordinated unit 140, e.g. a control system or control unit. The superordinated unit 140 can serve, for example, for control, visualizing and/or monitoring of a process, in which the field device 200 registers measurement data.

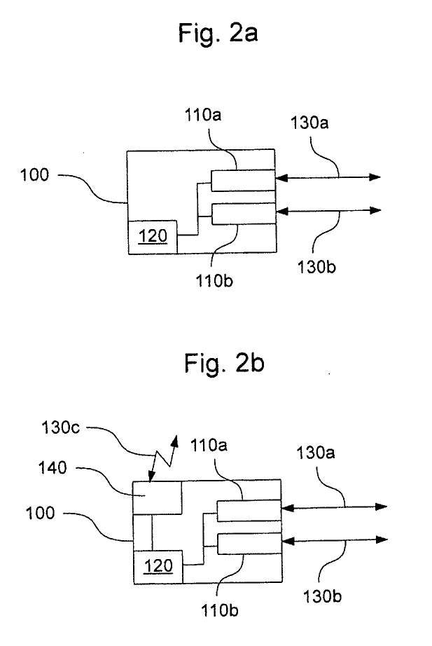

The plug connector module 100 of the invention can advantageously also include a number of different plug connectors 110a, 110b (compare FIG. 2a), so that it can be used with different field devices 200, or systems. For example, the first plug connector 110a can be designed to be Profibus compatible, while the second plug connector 110b is designed as an SMA plug connector, in order to enable high-frequency data transmission to other systems. Accordingly, the plug connector module 100 has available two different communication interfaces 130a, 130b, which enable data exchange with correspondingly compatible systems.

Data obtained both via the first communication interface 130a as well as also via the second communication interface 130b can, according to the invention, be stored in the memory unit 120. A data exchange in reverse direction is, of course, likewise possible. The plug connector module 100 enables, accordingly, an especially simple data exchange between Profibus compatible devices and devices with a high frequency capable, SMA plug connector.

The different plug connectors 110a, 110b can differ generally both as regards their mechanical shape as well as also the electrical parameters or a combination thereof.

In the case of an additional, advantageous variant of the invention, which is illustrated in FIG. 2b, a communication interface 130c is formed by a wireless data connection. Accordingly, the plug connector module 100 includes means 140 for establishing a wireless data connection with another device, e.g. the field device 200 of FIG. 1.

The means 140 can be, for example, a ZigBee- or Bluetooth-compatible transceiver, or a transceiver compatible with the widely distributed RFID tags.

The plug connector module 100 shown in FIG. 2b can, accordingly, advantageously, exchange data with other devices via two hardwired plug connectors 130a, 130b, and corresponding communication interfaces 130a, 130b, respectively; however, supplementally, also per radio via the communication interface 130c.

Application of an optical data connection is likewise possible, preferably via corresponding plug connectors (not shown), which are provided for establishing optical connections between light conducting fibers. Another way to implement an optical data connection is via an IrDA (Infrared Data Association)-compatible interface, in the case of which corresponding infrared transmitter and/or receiver can be integrated in a housing of the plug connector module 100 of the invention.

Especially in the case of a wireless data connection, it is no longer necessarily required to plug the plug connector module 100 of the invention with a plug connector 110a, 110b into the corresponding field device 200, or its suitable, i.e. complementary, plug connector (not shown). However, the added establishing of the electromechanical connection through the plug connector 110a, 110b can be used advantageously, for example, to start the automatic data exchange e.g. via the wireless data connection.

Preferably, the plug connector module 100 of the invention includes a not shown, integrated energy source for electrical energy supply, in the case of which it preferably can be a long-lived battery or also a high capacitance capacitor, especially a so-called double layer capacitor.

Alternatively or supplementally, also a likewise not shown, integrated energy supply unit can be provided for electrical energy supply, which is embodied to store and/or to transform electrical energy received via a plug connector 110a, 110b of the field device 200 or a data bus. For this, the integrated energy supply unit can make use of suitable (dc-)voltage converters and other circuits, or circuit components, known to those skilled in the art for electrical energy conversion.

Preferably, the plug connector module 100 of the invention includes also integrated means for interference suppression, which can be formed especially by at least one interference suppression resistor, which preferably is inserted serially into a data line of the at least one plug connector 110a, 110b. More complex filter networks, bandpass filters, components for deflection of overvoltages, etc. can likewise be integrated into the plug connector module 100 of the invention.

The plug connector module 100 of the invention enables especially simple data exchange between different or similar field devices 200. Especially in the case of an automatic data exchange, no special knowledge for servicing the individual field devices 200 is required, so that the transferring of configuration data from a first field device 200 to a second field device can also be performed by persons, who have no special knowledge for servicing the field devices.

Especially, the replacement of field devices 200 in process technology is greatly simplified by the use of the plug connector module 100 of the invention. Especially advantageously, application of the plug connector module 100 of the invention makes unnecessary a manual configuration of the field devices 200, which has always represented a significant source of error.

The plug connector module 100 of the invention can additionally be used advantageously as a data logger, i.e., besides the pure transferring of configuration data between a plurality of field devices 200, the plug connector module 100 of the invention permits e.g. a measuring point referenced capturing of data.

A plug connector 110a of the plug connector module 100 of the invention can advantageously also be embodied in such a manner, that the electrical contacts can be connected through to an additional, e.g. complementary plug connector (not shown), so that the plug connector module 100 can be inserted via this plug connector 110a, as well, into an existing data connection, e.g. between two field devices. In this application scenario, the plug connector module 100 is preferably applied as a data logger, which monitors communication between two existing field devices and stores such in its memory unit 120 for later evaluation.

1. A plug connector module having at least one plug connector for electromechanical connection with a field device, especially a device for measured data capture in process technology, wherein:
said plug connector module includes a memory unit for storing data and a communication interface, which enables a data connection with the field device.

2. The plug connector module as claimed in claim 1, wherein:
said plug connector module is embodied to read out configuration data from a connected field device automatically via said communication interface and to store such in said memory unit.

3. The plug connector module as claimed in claim 1, wherein:
said plug connector module is embodied to transfer configuration data stored in said memory unit automatically via said communication interface to said connected field device.

4. The plug connector module as claimed in claim 1, wherein:
said plug connector module is embodied to store, and/or to transfer between different field devices, a specific participant address of the field device, especially a Profibus address of a Profibus compatible field device.

5. The plug connector module as claimed in claim 1, wherein:
said memory unit includes a non-volatile memory, especially an EEPROM and/or flash EEPROM and/or MRAM memory.

6. The plug connector module as claimed in claim 1, wherein:
said memory unit includes a memory interface for connection with an external memory module, especially a USB (Universal Serial Bus), memory module or an SD memory card (Secure digital memory card).

7. The plug connector module as claimed in claim 5, further having means for locking said external memory module, especially for preventing an unauthorized removal of said external memory module, or a separation from said plug connector module.

8. The plug connector module as claimed in claim 1, wherein:
said communication interface is formed by the electromechanical connection implemented via said at least one plug connector; and
especially, a data line of the connection implemented via said at least one plug connector is used for forming a 1-wire interface.

9. The plug connector module as claimed in claim 1, wherein:
said communication interface is formed by a wireless and/or optical data connection; and
said plug connector module includes means for establishing a wireless and/or optical data connection with the field device.

10. The plug connector module as claimed in claim 1, further having an integrated energy source for electrical energy supply.

11. The plug connector module as claimed in claim 1, further having an integrated energy supply unit for electrical energy supply, which is embodied to store and/or to transform electrical energy received via a plug connector.

12. The plug connector module as claimed in claim 1, further having integrated means for interference suppression, especially by at least one interference suppression resistor, which is connected with a data line of the at least one plug connector.

13. The plug connector module as claimed in claim 1, wherein:
a plurality of different plug connectors are provided.

14. The plug connector module as claimed in claim 1, wherein:
said memory unit is designed, especially as regards its memory capacity, to record, as a data logger, measured values or other operational variables of the field device connected with the plug connector module.

15. A method for transferring data from a first field device to a second field device, comprising the steps of:
connecting a plug connector module a first field device;
storing data stored in the first field device, especially automatically, locally in the plug connector module;
connecting the plug connector module with a second field device; and
retrieving the data stored locally in the plug connector module and transferring the data to the second field device.

16. The method as claimed in claim 15, wherein:
the data are configuration data, which are stored in the first field device.

17. The method as claimed in claim 15, wherein:
the data comprise a specific, participant address of the first field device, especially a Profibus address of a Profibus compatible, field device.

18. The method as claimed in claim 15, wherein:
the data are transferred automatically by the plug connector module to the second field device.

19. The method as claimed in claim 15, wherein:
the data of the first field device are stored automatically locally in the plug connector module.
